(19) United States
(12) Patent Application Publication
(10) Pub. No.: US 2022/0325893 A1
(43) Pub. Date: Oct. 13, 2022

(54) CHAMBER FOR ROTATING DETONATION ENGINE AND WALL OBSTACLES FOR SAME

(71) Applicant: Raytheon Technologies Corporation, Farmington, CT (US)

(72) Inventors: Christopher Britton Greene, Hebron, CT (US); Peter AT Cocks, South Glastonbury, CT (US); Xiaoyi Li, Farmington, CT (US); James M. Donohue, Glastonbury, CT (US)

(73) Assignee: Raytheon Technologies Corporation, Farmington, CT (US)

(21) Appl. No.: 17/670,575

(22) Filed: Feb. 14, 2022

Related U.S. Application Data
(60) Provisional application No. 63/170,243, filed on Apr. 2, 2021.

(51) Int. Cl. F23R 3/56; F23R 3/12; F23R 3/50

(52) U.S. Cl. CPC F23R 3/56; F23R 3/12; F23R 3/50

(57) ABSTRACT

A combustor for a rotating detonation engine includes an outer tapered wall extending along an axis; an inner tapered wall extending along the axis, wherein the inner tapered wall is positioned within the outer tapered wall to define an annular combustion chamber having an annular gap between the outer tapered wall and the inner tapered wall, wherein the outer tapered wall is moveable relative to the inner tapered wall along the axis, and wherein movement of the outer tapered wall relative to the inner tapered wall changes the annular gap of the annular combustion chamber. Obstacles can be positioned on either or both of inner and outer wall to enhance turbulence within the combustion chamber.

### CROSS-REFERENCE TO RELATED APPLICATION

Benefit is claimed of U.S. Patent Application No. 63/170,243, filed Apr. 2, 2021, and entitled CHAMBER FOR ROTATING DETONATION ENGINE AND WALL OBSTACLES FOR SAME, the disclosure of which is incorporated by reference herein in its entirety as if set forth at length.

### BACKGROUND

The disclosure relates to rotating detonation engines and, more particularly, to structures and configuration of the walls defining the combustor of rotating detonation engines.

Rotating detonation engines are being considered for use to meet a wide variety of engine or propulsion needs. A rotating detonation engine (RDE) utilizes a controlled feed of fuel and oxidant to an annular chamber to generate a detonation wave rotating around the chamber at high speeds to generate thrust from an outlet of the chamber. Proper conditions to start and then maintain rotating detonation in the combustor are needed.

Some environments of use of an RDE require a wide operability range in addition to maintaining stable detonation operation. One such environment is in a ramjet engine.

Another aspect of stable operation of an RDE is obtaining good mixing of the fuel and oxidizer.

There is a need for an RDE with a wide operability range. Further, there is a need for such an RDE wherein the fuel and oxidizer are well mixed to strengthen and stabilize the detonation process.

### SUMMARY

In one non-limiting configuration, a combustor for a rotating detonation engine comprises an outer tapered wall extending along an axis; an inner tapered wall extending along the axis, wherein the inner tapered wall is positioned within the outer tapered wall to define an annular combustion chamber having an annular gap between the outer tapered wall and the inner tapered wall, wherein the outer tapered wall is moveable relative to the inner tapered wall along the axis, and wherein movement of the outer tapered wall relative to the inner tapered wall changes the annular gap of the annular combustion chamber.

In another non-limiting configuration, at least one of the outer tapered wall and the inner tapered wall is at least partially conical in shape.

In still another non-limiting configuration, the annular combustor chamber has an inlet end and an outlet end, and wherein the outer tapered wall and the inner tapered wall are parallel between the inlet end and the outlet end.

In a further non-limiting configuration, the annular combustor chamber has an inlet end and an outlet end, and the outer tapered wall and the inner tapered wall are divergent between the inlet end and the outlet end.

In a still further non-limiting configuration, the annular combustor chamber has an inlet end and an outlet end, and the outer tapered wall and the inner tapered wall are convergent between the inlet end and the outlet end.

In another non-limiting configuration, the combustor further comprises a movement mechanism for imparting relative movement to the outer tapered wall relative to the inner tapered wall.

In still another non-limiting configuration, the combustor further comprises a control unit communicated with operating parameters of the rotating detonation engine and with the movement mechanism, the control unit being configured and adapted to move at least one of the outer tapered wall and the inner tapered wall relative to the other of the outer tapered wall and the inner tapered wall based upon the operating parameters.

In a further non-limiting configuration, the outer tapered wall has an inner surface defining an outer diameter of the annular combustor chamber, and the inner tapered wall has an outer surface defining an inner diameter of the annular combustor chamber, and further comprising at least one flow obstacle on at least one of the inner surface and the outer surface.

In a still further non-limiting configuration, the flow obstacle comprises an elongate structure extending along the at least one of the inner surface and the outer surface and oriented at an angle (α) relative to the axis of between 0 and 30 degrees.

In another non-limiting configuration, a rotating detonation engine system, comprises an inlet for fuel and oxidant to an annular combustion chamber of a rotating detonation combustor; an outer tapered wall extending along an axis; an inner tapered wall extending along the axis, wherein the inner tapered wall is positioned within the outer tapered wall to define the annular combustion chamber having an annular gap between the outer tapered wall and the inner tapered wall, wherein the outer tapered wall is moveable relative to the inner tapered wall along the axis, and wherein movement of the outer tapered wall relative to the inner tapered wall changes the annular gap of the annular combustion chamber; and an exhaust communicated with an outlet of the annular combustion chamber.

In still another non-limiting configuration, at least one of the outer tapered wall and the inner tapered wall is at least partially conical in shape.

In a further non-limiting configuration, the annular combustor chamber has an inlet end and an outlet end, and the outer tapered wall and the inner tapered wall are parallel between the inlet end and the outlet end.

In a still further non-limiting configuration, the annular combustor chamber has an inlet end and an outlet end, and the outer tapered wall and the inner tapered wall are divergent between the inlet end and the outlet end.

In another non-limiting configuration, the annular combustor chamber has an inlet end and an outlet end, and the outer tapered wall and the inner tapered wall are convergent between the inlet end and the outlet end.

In still another non-limiting configuration, the system further comprises a movement mechanism for imparting relative movement to the outer tapered wall relative to the inner tapered wall.

In a further non-limiting configuration, the system further comprises a control unit communicated with operating parameters of the rotating detonation engine and with the movement mechanism, the control unit being configured and adapted to move at least one of the outer tapered wall and the inner tapered wall relative to the other of the outer tapered wall and the inner tapered wall based upon the operating parameters.

In a still further non-limiting configuration, the outer tapered wall has an inner surface defining an outer diameter of the annular combustor chamber, and the inner tapered wall has an outer surface defining an inner diameter of the annular combustor chamber, and further comprising at least one flow obstacle on at least one of the inner surface and the outer surface.

In another non-limiting configuration, the flow obstacle comprises an elongate structure extending along the at least one of the inner surface and the outer surface and oriented at an angle (α) relative to the axis of between 0 and 30 degrees.

In still another non-limiting configuration, a combustor for a rotating detonation engine comprises an outer wall extending along an axis; an inner wall extending along the axis, wherein the inner wall is positioned within the outer wall to define an annular combustion chamber having an annular gap between the outer wall and the inner wall, wherein the outer wall has an inner surface defining an outer diameter of the annular combustor chamber, and wherein the inner wall has an outer surface defining an inner diameter of the annular combustor chamber, and further comprising at least one flow obstacle on at least one of the inner surface and the outer surface.

In a further non-limiting configuration, the flow obstacle comprises an elongate structure extending along the at least one of the inner surface and the outer surface and oriented at an angle (α) relative to the axis of between 0 and 30 degrees.

The present disclosure may include any one or more of the individual features disclosed above and/or below alone or in any combination thereof.

### BRIEF DESCRIPTION OF THE DRAWINGS

A detailed description follows, with reference to the accompanying drawings, wherein:

FIG. 1 schematically illustrates a rotating detonation engine;

FIG. 2 illustrates a non-limiting configuration of a tapered wall rotating detonation engine;

FIG. 3 illustrates an articulated tapered wall structure of a rotating detonation engine in a position to define a small combustor chamber annulus;

FIG. 4 illustrates the articulated tapered wall structure of FIG. 3 with the tapered walls moved to a position to define a large combustor chamber annulus;

FIG. 5 schematically illustrates a non-limiting configuration having divergent walls;

FIG. 6 schematically illustrates a non-limiting configuration having convergent walls;

FIG. 7 schematically illustrates a non-limiting configuration of an obstacle for a rotating detonation engine combustor;

FIG. 8 schematically illustrates flow and detonation wave direction in a combustor, and one non-limiting orientation of an obstacle;

FIG. 9 schematically illustrates a further non-limiting configuration of an obstacle for a rotating detonation engine combustor; and

FIG. 10 schematically illustrates flow and detonation wave direction in a combustor, and another non-limiting orientation of an obstacle.

### DETAILED DESCRIPTION

The disclosure relates to a combustor chamber for a rotating detonation engine. As disclosed herein, the combustor chamber can be defined as an annular space between two tapered or conical walls, and these walls can be articulated or movable relative to each other such that spacing between the tapered walls can be adjusted, thereby enhancing the operability range of the rotating detonation engine.

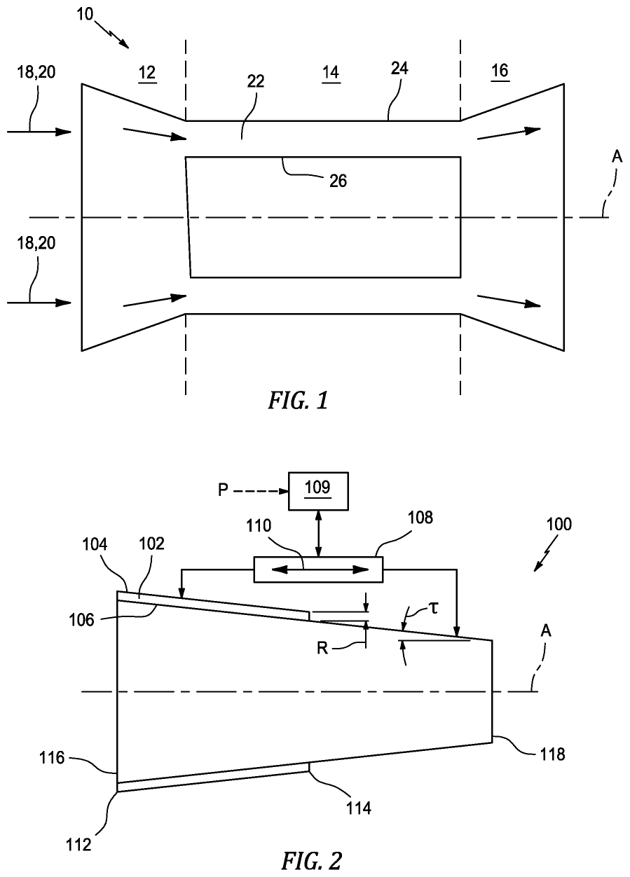

FIG. 1 schematically illustrates a rotating detonation engine 10 having an inlet portion 12, a combustor portion 14 and an exhaust portion 16. At the inlet portion 12, fuel and oxidant (represented schematically by arrows 18, 20) are mixed and fed to the combustor portion 14 where rotating detonation is initiated and maintained.

Combustor portion 14 is defined as an annular space 22 between an outer generally cylindrical wall 24 and an inner generally cylindrical wall 26. In this annular space 22, a combustor is defined wherein a detonation wave rotates around annular space 22 at a very high speed while traveling toward an outlet of combustor portion 14 leading to exhaust portion 16.

At exhaust portion 16, a potentially large thrust is generated as the combustion products expand out of the combustor portion 14.

In the schematic representation of FIG. 1, it can be appreciated that the walls 24, 26 that define annular space 22 define a fixed flow volume and annulus size (radial dimension of the ring defined between inner and outer walls of the annulus) along the length or axis A of the combustor portion 14. Although the rotating detonation engine 10 is shown as an annular structure, one skilled in the art will realize that a rotating detonation engine may have any shape that provides a continuous path for detonation to follow. For example, a rotating detonation engine may have an elliptical shape, a trapezoidal shape, or the like. In that regard, where used in this context, “annulus” may refer to any continuous circumferential channel having annular or any other shape such as trapezoidal or elliptical. Furthermore, where used herein, “annular volume” may likewise refer to any continuous circumferential channel having annular or any other shape such as trapezoidal or elliptical.

FIG. 2 shows a non-limiting configuration of a combustor 100 as disclosed herein, wherein an annular combustor chamber 102 is defined between an outer tapered wall 104 and an inner tapered wall 106. Further, a movement mechanism schematically illustrated at 108 is provided to allow movement of at least one of outer tapered wall 104 and inner tapered wall 106 relative to the other in the direction of arrow 110. Due to the taper of the wall, such movement changes the radial spacing R between the walls, and thereby adjusts both the annulus size and the flow volume of the annular combustor chamber 102. This can greatly expand the operability range of the rotation detonation engine having combustor 100 as disclosed herein. In the configuration shown in FIG. 2, it will be appreciated that the tapered walls are tapered in a downstream or flow direction. That is, these tapered walls have a diameter that decreases in a downstream or flow direction. It will be appreciated that similar flow adjustment can be accomplished with walls that are conical in shape and have a diameter that increases in a flow or downstream direction. In such a configuration, the walls would be considered to taper in an upstream direction. It is particularly useful, however, within this broad definition of tapering, to have the conical walls taper in a downstream direction as is illustrated in the drawings. As will be discussed further below, it is not necessary for the walls to be parallel, and in fact it can be useful for the walls to be tapered at different angles so as to diverge or converge relative to each other, so long as the walls are tapered in the same direction, that is, both walls taper either toward the outlet end or toward the inlet end.

Outer tapered wall 104 can be a conical wall having a large diameter 112 at one end and tapering to a smaller diameter 114 at the other end. The tapering as shown in FIG. 2 is along axis A, which corresponds to the general flow direction from inlet end to outlet end of chamber 102. Thus, in the configuration of FIG. 2, the diameter of outer tapered wall 104 decreases from an inlet end along axis A toward an outlet end of combustor 100.

Inner tapered wall 106 can also be a conical wall having a large diameter 116 at one end and tapering to a smaller diameter 118 at the other end. The tapering of inner tapered wall 106, in this configuration, is similar to that of outer tapered wall 104 such that the diameter of inner tapered wall 106 decreases from an inlet end along axis A toward an outlet end of combustor 100.

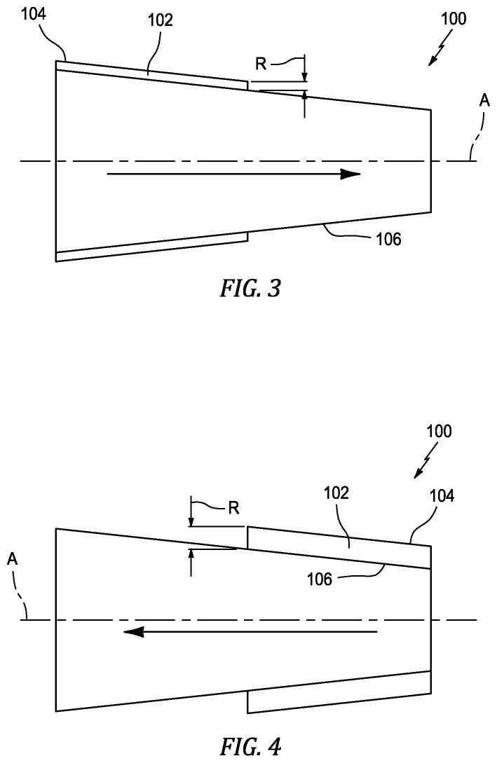

Movement mechanism 108 can be any suitable mechanical connection between either or both of outer and inner tapered walls 104, 106 and a static structure, or between walls 104, 106 themselves, and is configured to allow relative movement of one wall relative to the other along axis A. This is further illustrated in FIGS. 3 and 4. For example, movement mechanism 108 can be an electric motor with gearing to transmit motion to one or the other of walls 104, 106.

FIG. 3 shows inner tapered wall 106 moved to the right relative to outer tapered wall 104 such that the size of the annulus, or radial spacing (R) between walls, is at a relatively small annulus size. When a larger spacing (R) or annulus size is desired, inner tapered wall 106 can be moved to the left (as seen in FIG. 4) relative to outer tapered wall 104 such that the annular spacing R is larger. FIGS. 3 and 4 schematically imply that inner tapered wall 106 is moving, but it should be appreciated that either or both of outer and inner walls 104, 106 can be configured to be moveable.

Movement of one wall relative to the other wall is referred to herein as articulation. As used herein, articulation refers to simple relative movement of one component relative to the other, with no specific type of movement or orientation of movement being implied. In the embodiment illustrated in FIGS. 3 and 4, this articulation can be seen as a translational movement back and forth along axis A. Other configurations wherein movement between outer and inner walls 104, 106 is not strictly translational can also be utilized.

Articulation of one tapered wall relative to the other results in a change in the radial gap size of the annulus, which can accommodate changes in overall flowrate, or can adjust the pressure-flow balance to sustain rotating detonation operation, or both in combination.

A control unit 109 (FIG. 2) can be communicated with movement mechanism 108 and also with operating parameters of the RDE, schematically indicated at P. Operating parameters P can be collected by one or more sensors within RDE, or can be generated from other measured or expected input, and used by control unit 109 to determine and send suitable control commands to movement mechanism 108 to cause a desired relative movement between wall 104 and wall 106 and thereby adjust the annular spacing R to a desired flow condition. Control unit 109 can be defined by, as one non-limiting example, a processor or controller programmed with the necessary logic to determine machine commands to be sent to the movement mechanism on the basis of input received by the control unit. As a further non-limiting example, if operating parameters P indicate that a higher velocity out of annular chamber 102 is desired, a command could be sent to movement mechanism 108 to cause relative movement to decrease spacing R and thereby decrease flow area and increase velocity.

In the embodiment of FIGS. 2-4, tapered walls 104, 106 are tapered parallel to each other. It should be appreciated that these walls can alternatively be arranged divergent or convergent as well, as each of these configurations can create useful flow and operability control.

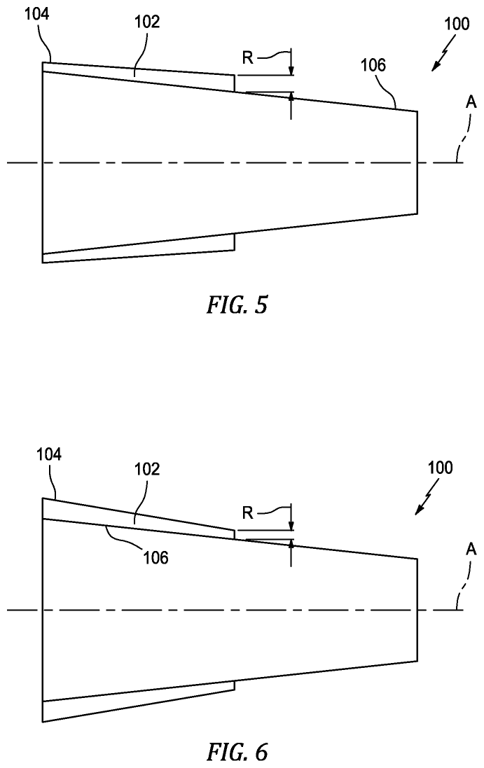

FIG. 5 schematically illustrates an embodiment wherein outer tapered wall 104 diverges with respect to inner tapered wall. In this configuration, the annular gap R increases along the combustor axis A. Such divergent walls can be desirable as they allow an increasing spacing R which can be balanced against the decreasing diameter of walls 104, 106 to provide a constant flow area as flow moves downstream, which is a potentially important factor in allowing the expansion process in the RDE. Further, a divergent wall configuration can be useful for increasing flow area and thereby decreasing flow velocity.

FIG. 6 schematically illustrates an alternative configuration wherein walls 104, 106 converge along the direction of axis A such that a decreasing area change of flow can be created as flow moves downstream. A convergent wall configuration can be useful to decrease flow area and thereby increase flow velocity.

In a further non-limiting configuration, while the illustrations of FIGS. 5 and 6 show walls tapering inwardly, it can also be useful to have these walls tapering outwardly, again with articulation of one wall relative to the other to provide the same adjustable flow conditions as discussed above.

The taper of walls 104, 106 can be measured at a taper angle (τ) (FIG. 2) relative to axis A (drawn relative to a parallel line to axis A) of between greater than 0 degrees and up to as much as 35 degrees if desired, depending upon other device characteristics. Within this broad range, a taper angle (τ) of between 2 and 15 degrees is particularly useful. Further, the taper angle for each wall 104, 106 does not need to be the same, as in the convergent and divergent configurations discussed above.

As set forth above, another important consideration in stable operation of an RDE is good mixture of the fuel and oxidant. In another aspect of the present disclosure, chamber wall obstacles are incorporated into the combustor to create turbulence which is a mechanism for creating Deflagration-to-Detonation Transitions (DDTs) which can help to initiate, strengthen and sustain the detonation wave to be generated and circulated in annular combustor chamber 102.

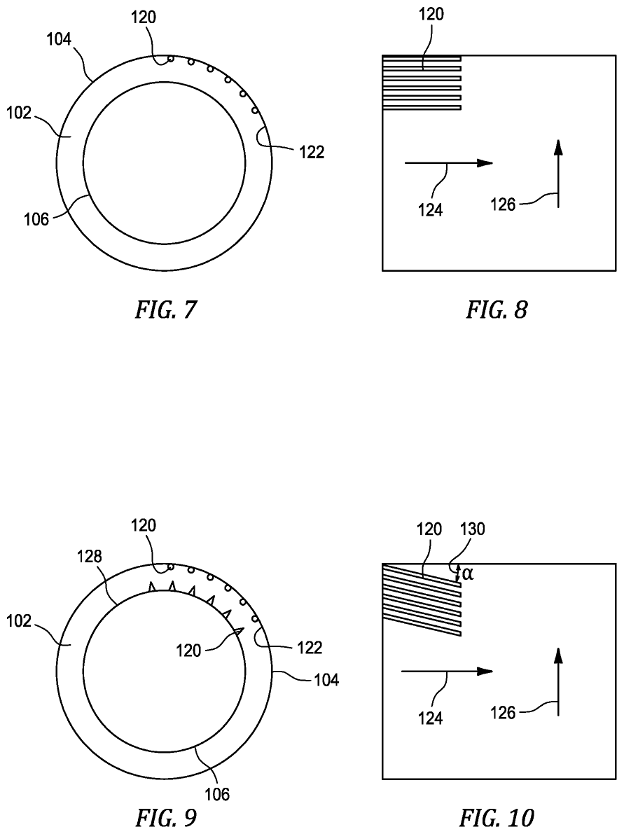

FIG. 7 schematically illustrates an annulus end view of outer and inner walls 104, 106, with obstacles 120 which in this case are positioned on an inner surface 122 of outer wall 104. Obstacles can be one or more elongate structures positioned along the wall surface to impact the detonation wave and enhance turbulence. These elongate structures can be ridges, round shaped rods, rectangular strips, or more complicated shapes such as triangle shaped ramps or the like. Obstacles can be arranged axially along the length of the combustor chamber, or circumferential, or at an angle to the axis which can resemble a spiral.

FIG. 8 shows a schematic representation of flow direction 124 and wave direction 126 within an RDE combustor. In this configuration, obstacles 120 are shown aligned with the flow direction, which would generally create good mixing and turbulence while causing minimal pressure drop to the flow.

Obstacles 120 may be provided at specific locations within the combustor chamber, for example at specific locations around the full 360 degree annulus, or at specific positions along the axis or axial length. For example, it may be desirable to provide obstacles at a location where enhanced mixing of fuel is needed, for example at the inlet end of the combustor chamber, or in areas that are shown to need such additional mixing. In FIG. 8, obstacles are only shown at an inlet end, and only around a portion of the circumference.

Obstacles can be positioned on the inner surface of outer wall 104, or on the outer surface of inner wall 106, or both. FIG. 9 shows a non-limiting configuration wherein obstacles 120 are on both inner surface 122 of outer wall 104, and also on outer surface 128 of inner wall 106. Further, while obstacles 120 on outer wall 104 are shown as simple rod shapes, obstacles on inner wall 106 are shown as triangular in shape. It should be appreciated that obstacles could also be provided only on the inner wall 106, and further that differently shaped obstacles can be combined as shown in FIG. 9, if desired.

It will be appreciated that obstacles 120 can be angled relative to the flow direction to create a helical pattern as mentioned above. This may most closely match the actual flow through the combustor, and therefore it can be desirable to angle obstacles relative to axis A (or the flow direction 124) at an angle (α) of between 0 and 30 degrees. FIG. 10 shows such a configuration, where obstacles 120 are at an angle (α), also numbered 130, relative to flow direction 124 of about 25 degrees.

One or more embodiments have been described. Nevertheless, it will be understood that various modifications may be made. For example, walls could be tapered in the opposite direction. Further, different shapes and configurations of obstacles could be utilized. These modifications can influence details of particular implementations. Accordingly, other embodiments are within the scope of the following claims.

We claim:

1. A combustor for a rotating detonation engine, the combustor comprising:
an outer tapered wall extending along an axis;
an inner tapered wall extending along the axis, wherein the inner tapered wall is positioned within the outer tapered wall to define an annular combustion chamber having an annular gap between the outer tapered wall and the inner tapered wall, wherein the outer tapered wall is moveable relative to the inner tapered wall along the axis, and wherein movement of the outer tapered wall relative to the inner tapered wall changes the annular gap of the annular combustion chamber.

2. The combustor of claim 1, wherein at least one of the outer tapered wall and the inner tapered wall is at least partially conical in shape.

3. The combustor of claim 1, wherein the annular combustor chamber has an inlet end and an outlet end, and wherein the outer tapered wall and the inner tapered wall are parallel between the inlet end and the outlet end.

4. The combustor of claim 1, wherein the annular combustor chamber has an inlet end and an outlet end, and wherein the outer tapered wall and the inner tapered wall are divergent between the inlet end and the outlet end.

5. The combustor of claim 1, wherein the annular combustor chamber has an inlet end and an outlet end, and wherein the outer tapered wall and the inner tapered wall are convergent between the inlet end and the outlet end.

6. The combustor of claim 1, further comprising a movement mechanism for imparting relative movement to the outer tapered wall relative to the inner tapered wall.

7. The combustor of claim 6, further comprising a control unit communicated with operating parameters of the rotating detonation engine and with the movement mechanism, the control unit being configured and adapted to move at least one of the outer tapered wall and the inner tapered wall relative to the other of the outer tapered wall and the inner tapered wall based upon the operating parameters.

8. The combustor of claim 1, wherein the outer tapered wall has an inner surface defining an outer diameter of the annular combustor chamber, and wherein the inner tapered wall has an outer surface defining an inner diameter of the annular combustor chamber, and further comprising at least one flow obstacle on at least one of the inner surface and the outer surface.

9. The combustor of claim 8, wherein the flow obstacle comprises an elongate structure extending along the at least one of the inner surface and the outer surface and oriented at an angle (α) relative to the axis of between 0 and 30 degrees.

10. A rotating detonation engine system, comprising:
an inlet for fuel and oxidant to an annular combustion chamber of a rotating detonation combustor;
an outer tapered wall extending along an axis;
an inner tapered wall extending along the axis, wherein the inner tapered wall is positioned within the outer tapered wall to define the annular combustion chamber having an annular gap between the outer tapered wall and the inner tapered wall, wherein the outer tapered wall is moveable relative to the inner tapered wall along the axis, and wherein movement of the outer tapered wall relative to the inner tapered wall changes the annular gap of the annular combustion chamber; and
an exhaust communicated with an outlet of the annular combustion chamber.

11. The system of claim 10, wherein at least one of the outer tapered wall and the inner tapered wall is at least partially conical in shape.

12. The system of claim 10, wherein the annular combustor chamber has an inlet end and an outlet end, and wherein the outer tapered wall and the inner tapered wall are parallel between the inlet end and the outlet end.

13. The system of claim 10, wherein the annular combustor chamber has an inlet end and an outlet end, and wherein the outer tapered wall and the inner tapered wall are divergent between the inlet end and the outlet end.

14. The system of claim 10, wherein the annular combustor chamber has an inlet end and an outlet end, and wherein the outer tapered wall and the inner tapered wall are convergent between the inlet end and the outlet end.

15. The system of claim 10, further comprising a movement mechanism for imparting relative movement to the outer tapered wall relative to the inner tapered wall.

16. The system of claim 15, further comprising a control unit communicated with operating parameters of the rotating detonation engine and with the movement mechanism, the control unit being configured and adapted to move the outer tapered wall relative to the inner tapered wall based upon the operating parameters.

17. The system of claim 10, wherein the outer tapered wall has an inner surface defining an outer diameter of the annular combustor chamber, and wherein the inner tapered wall has an outer surface defining an inner diameter of the annular combustor chamber, and further comprising at least one flow obstacle on at least one of the inner surface and the outer surface.

18. The system of claim 17, wherein the flow obstacle comprises an elongate structure extending along the at least one of the inner surface and the outer surface and oriented at an angle (α) relative to the axis of between 0 and 30 degrees.

19. A combustor for a rotating detonation engine, the combustor comprising:
an outer wall extending along an axis;
an inner wall extending along the axis, wherein the inner wall is positioned within the outer wall to define an annular combustion chamber having an annular gap between the outer wall and the inner wall, wherein the outer wall has an inner surface defining an outer diameter of the annular combustor chamber, and wherein the inner wall has an outer surface defining an inner diameter of the annular combustor chamber, and further comprising at least one flow obstacle on at least one of the inner surface and the outer surface.

20. The combustor of claim 19, wherein the flow obstacle comprises an elongate structure extending along the at least one of the inner surface and the outer surface and oriented at an angle (α) relative to the axis of between 0 and 30 degrees.
